(19) United States
(12) Patent Application Publication
(10) Pub. No.: US 2018/0137700 A1
(43) Pub. Date: May 17, 2018

(54) AMUSEMENT ATTRACTION HAVING SMART SENSING OR CONTROL CAPABILITIES

(71) Applicant: Whitewater West Industries Ltd., Richmond (CA)

(72) Inventors: Patrick L. Finnegan, Baraboo, WI (US); Timothy B. Kwasnicki, Delta (CA); Claudio J. Barrera, South Surrey (CA); Richard A. Sebulsky, Delta (CA)

(21) Appl. No.: 15/812,662

(22) Filed: Nov. 14, 2017

Related U.S. Application Data
(60) Provisional application No. 62/421,806, filed on Nov. 14, 2016.

(51) Int. Cl. G07C 9/00; A63G 21/18; G06K 19/07

(52) U.S. Cl. CPC G07C 9/00126; G06K 19/0723; A63G 21/18

(57) ABSTRACT

An intelligent amusement attraction using one or more equipment or components for controlling operation of the amusement attraction. The amusement attraction may employ as “smart start” system that interfaces with one or more components, such as weight detecting components, height detecting components, fluid flow detecting components, fluid level sensing components, pressure sensing components, etc. and uses signals from such components for controlling whether a rider is permitted to enter the attraction. This entrance may be controlled automatically or through use of a ride operator. The amusement attraction may also or additionally employ a “smart flow” system that controls flow of water or other power or features to parts of an amusement attraction based upon the sensing of a rider or user at one or more particular locations along or at the amusement attraction.

### CROSS REFERENCE TO RELATED APPLICATIONS

This application claims the benefit of U.S. Provisional Patent Application Ser. No. 62/421,806, filed on Nov. 14, 2016, entitled “AMUSEMENT ATTRACTION HAVING SMART SENSING OR CONTROL CAPABILITIES,” which is hereby incorporated by reference in its entirety.

### BACKGROUND

### 1. Field of the Invention

The present invention relates to an apparatus, system, and/or method for controlling operation of an amusement attraction, such as a waterslide or water attraction. More particularly, the present invention relates to an apparatus, system, and/or method for controlling operation of an amusement attraction and/or entry to a portion of an amusement attraction based upon sensing or determining one or more rider characteristics, attraction operation, and/or rider location.

### 2. Description of the Related Art

Amusement attractions and water slides are a popular form of entertainment for patrons, with water slides being particularly desired in warmer months of the year and conventionally operate by allowing one or more riders to travel along a slide, flume, or other ride surface from one elevation to another elevation. The rider(s) may be positioned upon a ride vehicle, such as an inflatable inner tube, board, etc. and may travel along the slide upon a flow of water. In other water slides, the rider(s) may instead travel along a water slide without any ride vehicle. A stream or volume of water is conventionally flowed along the entire slide for the rider(s) to travel upon as they move along the slide, aiding in the reduction of friction while traveling along the slide. In other amusement attractions, no water may be present at all and the rider may travel along the attraction due to a low coefficient of friction, for example, upon a ride vehicle (such as cloth or fabric) or without a ride vehicle.

Conventional attractions often rely upon employees or operators of the slide to help control rider throughput and/or manage the attraction queue lines. For example, to control rider throughput of two or more riders that are using a waterslide in succession, an employee for the waterslide may be in charge of ensuring that a new rider does not enter the water slide until a prior rider has reached a particular location along the water slide (or has already exited the waterslide). Likewise, such employees typically are charged with enforcing any other regulations for the particular water slide (e.g., height, weight, age, or other requirements or restrictions).

Ideally, an improved amusement attraction, including water attractions such as waterslides, would be capable of intelligently managing fluid flow or other characteristics required for successful operation of the ride in order to aid in controlling ride throughput, efficiency, cost-of-operation, maintenance, equipment or attraction status, and/or other various attributes. Moreover, employee enforcement of regulations, restrictions, guidelines, or other operating procedures would ideally be improved.

### SUMMARY

The present invention is related to a system and method for intelligently controlling operation of an amusement attraction, such as a waterslide or water attraction, based upon rider characteristics, rider location, and/or equipment or attraction status. Such intelligent operation can help improve control over ride throughput and/or management of queue lines, efficiency, cost-of-operation, maintenance, equipment or attraction status, or other various attributes. In one embodiment, an amusement attraction for riding by a rider may include a ride surface having a loading portion and a ride portion, a weight detecting component configured to determine a weight corresponding to the rider, and a status indicator configured to indicate whether the attraction permits entrance by the rider based upon the weight detecting component, wherein the rider is automatically prevented from transitioning from the loading portion of the ride surface to the ride portion of the ride surface if the status indicator indicates entrance by the rider is not permitted, for example, based upon a failure to meet certain pre-determined qualifications or parameters.

In another embodiment, a water attraction includes a sliding surface configured to support a rider thereon, the sliding surface having a first zone, and a sensor configured to sense the rider when the rider is in a first position along the sliding surface, wherein a flow of water is configured to flow upon the first zone of the sliding surface based on the sensor sensing the rider when the rider is in the first position along the sliding surface.

In still another embodiment, a method for controlling an amusement attraction for riding by a rider (and/or a ride vehicle) includes determining a characteristic of the rider (and/or the ride vehicle), comparing the characteristic of the rider (and/or the ride vehicle) with a parameter of the amusement attraction, determining prohibition of the rider (and/or the ride vehicle) based upon the comparing of the characteristic of the rider (and/or the ride vehicle) with the parameter of the amusement attraction, and indicating allowance of the rider (and/or the ride vehicle) based upon the determining of the prohibition of the rider (and/or the ride vehicle).

### BRIEF DESCRIPTION OF THE DRAWINGS

The features, objects, and advantages of the present invention will become more apparent from the detailed description set forth below when taken in conjunction with the drawings, wherein:

FIG. 1 shows a schematic overhead view of an entrance to an amusement attraction and incorporating associated equipment and controls, according to one embodiment of the present invention;

FIG. 2 shows a schematic side view of a portion of a water attraction and incorporating associated equipment and controls, according to one embodiment of the present invention;

FIG. 3 shows a side view of a portion of a slide in a water attraction and incorporating associated equipment and/or controls, according to one embodiment of the present invention;

FIG. 4 shows a side view of an end portion of a slide in a water attraction and incorporating associated equipment and/or controls, according to one embodiment of the present invention; and

FIG. 5 shows a flowchart for a method of operation of an attraction based upon rider characteristics and/or attraction status, according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

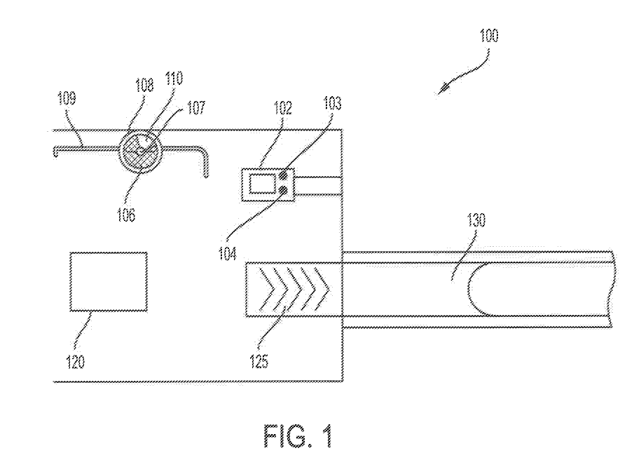

FIG. 1 illustrates a schematic view of an entrance area 100 to an amusement attraction and incorporating associated equipment and controls, as discussed in greater detail herein. The amusement attraction may be fluid (e.g., water) based or may be a non-fluid based attraction (e.g., a dry slide or other attraction) or a combined fluid and non-fluid based attraction that allows users to interact therewith or thereon. The entrance area 100 to the amusement attraction may include a loading zone 125 that permits riders and/or ride vehicles to initially engage or interact with a portion of the amusement attraction prior to traveling onto a further portion 130 (e.g., a slide or flume, such as a completely closed flume or an open flume) of the amusement attraction. As previously discussed, conventional attractions, particularly water attractions or slides, rely mainly upon employees of a waterpark or other facility in charge of the operation of the attraction to manage the entry of riders from a loading zone, such as the loading zone 125, to a further portion, such as the further portion 130, of the attraction.

FIG. 1 also illustrates additional equipment and/or components that may allow (e.g., automatically or at least partially based upon outside intervention) or provide for rider and/or ride vehicle transition from the loading zone 125 to the further portion 130 of the attraction, as discussed in greater detail herein. Such additional equipment and/or components may further aid in operation and/or management of the attraction, for example, to help control throughput and/or management of queue lines for the attraction. For example, a “Smart Start” system for the attraction may have one or more modes that identify and/or control whether the attraction is OK for rider and/or ride vehicle entry or interaction (e.g., a “NO GO” mode where rider entry is not desired and a “GO” mode where rider entry is desired). Additional and/or alternative modes may be used in alternative embodiments. As discussed in greater detail herein, a variety of possible equipment, components, and/or inputs may be provided for such a “Smart Start” system in order to make determinations or provide other functionality relating to the one or more modes of the attraction.

For example, one item of additional equipment and/or component that may be provided for the above-discussed “Smart Start” system and/or aid in allowing (e.g., automatically) or providing for a rider and/or ride vehicle to transition from the loading zone 125 to the further portion 130 is a weight detecting component or scale 120 (e.g., an electronic scale). The scale 120 may be provided adjacent to a privacy screen in certain embodiments in order to protect rider privacy as to how much the rider weighs. For example, the privacy screen may be a physical device or barrier (e.g., a wall, a sheet, etc.) that prevents other riders and/or ride operators of the attraction from viewing at least a portion of the rider that is presently using the scale 120 or a portion of the scale 120 or its associated equipment itself. In another example, the rider using the scale 120 may be fully viewable by other riders of the attraction, but the indication as to rider weight may be obscured and/or prevented from viewing by such other riders. In one embodiment, the weight detecting component 120 may be included, incorporated, or connected with into a component (e.g., a fiberglass panel) of the loading zone 125. In one embodiment, the scale 120 may incorporate or be connected with a display (e.g., a digital display) that identifies a specific weight for the rider using the scale 120. In another embodiment, the scale 120 may incorporate or be connected with an indication as to the acceptability of the rider using the scale 120 to participate further with the attraction (e.g., a green-light may illuminate indicating that the rider has an acceptable weight as determined by the scale 120, a red-light may illuminate indicating the rider does not have an acceptable weight as determined by the scale 120, a sound may play indicating to an employee and/or the rider using the scale 120 that the rider has an acceptable weight as determined by the scale 120, etc.). Any of a variety of possible displays or other indications may be possible in alternative embodiments.

The scale 120 or other weight sensing device may be used and/or placed in the vicinity of the loading zone 125. In an alternative embodiment, the scale 120 may be placed in any of a variety of other locations (e.g., at an entrance or within a queue line for the attraction, etc.). In one example, the scale 120 may be built into a path, walkway, or other structural element that riders must use in order to reach the loading zone 125 of the attraction. In such an example, the scale 120 may be beneficially placed such that a rider is determined to have an acceptable weight for use of the attraction before the rider waits in a queue line for the attraction. The scale 120 may be used to measure a weight of an upcoming rider that wishes to interact with the attraction. The attraction may specify a particular weight that is required in order for a rider to be permitted to ride upon or enter the attraction. In certain embodiments, more than one weight may be used to define operational parameters (e.g., a minimum weight and a maximum weight). In still other embodiments, different weights may be used to specify or determine different operational requirements on the same ride.

For example, for attractions whereby multiple riders traverse the attraction, such as simultaneously, a total weight may be calculated, by the scale 120 and/or by other equipment connected with the scale 120 (e.g., a computer or electronic processor). For example, if an attraction uses a multi-rider ride vehicle capable of carrying six riders, the attraction and/or the ride vehicle may have a minimum and/or maximum weight guideline or requirement for operation. In such an example, the scale 120 and/or other equipment connected with the scale 120 may be configured to sum each of the riders' weights that will be riding within the multi-rider ride vehicle to ensure that a total weight is between minimum and/or maximum weight thresholds.

In another embodiment, for attractions whereby multiple riders traverse the attraction, such as simultaneously, different rider's weights may be desired in order to provide for the placement of particular riders in certain seats or other areas of a ride vehicle or other area of the attraction. For example, if an attraction uses a multi-rider ride vehicle capable of carrying six riders and a particular weight distribution around the ride vehicle is desired (e.g., a substantially balanced or uniform weight distribution), the scale 120 and/or other equipment connected with the scale 120 may be configured to determine and/or indicate the positioning of particular riders in the ride vehicle for the purpose of achieving the desired weight distribution. In still another example, an attraction may use a multi-rider ride vehicle where a particular position within the ride vehicle is ideally used by a rider weighs more than other rides (e.g., a heaviest rider may be desired at a front and/or a rear of a ride vehicle). In such an example, the scale 120 and/or other equipment connected with the scale 120 may be configured to determine and/or indicate which rider should be positioned within which position (e.g., determine the heaviest rider and indicate that such rider should be positioned at a particular ride vehicle location, such as the front or the rear).

In still another embodiment, an attraction may be configured to operate in alternative manners and/or include alternative features or characteristics depending upon the weight of a rider and/or multiple riders or the combination of the rider(s) and ride vehicle(s) interacting with the attraction. For example, water volume, water flow rate, water depth, water speed and/or another characteristic for the attraction and/or its features may be configured for the particular rider weight (whether individual rider or summation of multiple riders) or the combination of the rider(s) and ride vehicle(s). Any of a variety of possible ride characteristics or desired operations may be tied to a weight and/or multiple weights (e.g., summation of weights) that are setup for the attraction for control of rider throughput and/or management of queue lines, or other guideline, regulation, safety purposes, equipment status, or attraction feature.

The “Smart Start” system may, in one embodiment, configure the attraction to be put into the “NO GO” mode for preventing the rider or riders and/or ride vehicle(s) from entering the attraction (e.g., transitioning from the loading zone 125 to the further portion 130) when the scale 120 provides a number or numbers that do not meet the attraction requirements. When the “Smart Start” system is in the “NO GO” mode, the loading zone 125 may prevent a rider and/or ride vehicle from automatically entering the further portion 130 of the attraction (e.g., a conveyer belt may be disabled or allowed to remain off to prevent rider movement, a blocking gate or bar may be placed in the way of the rider and/or ride vehicle preventing entrance, water or fluid jets may be disabled or allowed to remain off to prevent rider and/or ride vehicle movement, etc.).

In certain embodiments, the scale 120 may be included as part of or incorporated into one or more areas of the loading zone 125 such that the loading zone 125 can sense the rider and/or ride vehicle weight and/or other rider and/or ride vehicle characteristic. In various embodiments, the scale 120 need not provide an explicit numerical or range of numerical values for a rider and/or ride vehicle, but rather may merely provide notice to the rider, attendant, and/or the ride itself that the rider and/or ride vehicle is within the desired and/or operating thresholds. For example, such operation may be provided without providing any notice to the riders themselves or other attendants that a weight and/or other characteristic has even been measured, other than the ride indicating (e.g., via a gate or other notification or indication element or system) that the rider and/or ride vehicle is acceptable for entry onto the ride.

In such an embodiment, the scale 120 or portion of the loading zone 125 that measures a characteristic of the rider and/or ride vehicle may provide no indicators that the scale 120 and/or the loading zone 125 has such sensing equipment provided therein and/or is capable of sending the approval of the characteristic of the rider and/or ride vehicle to a system of the ride and/or an attendant. Such operation or features may be used for any of a variety of rider and/or ride vehicle characteristics. For example, height, weight, age, sex, etc. For example, with respect to determining a height or heights of one or more riders, a beam of light or a laser may be disposed at a desired or required height and rider entrance prohibited unless the beam is broken or not broken in a desired fashion in accordance with ride parameters and/or thresholds. In another example, other rider characteristics may be stored upon a device (e.g., electronic card or tag (e.g., RFID) that is carried and/or worn by riders) and is read by the “Smart Start” system to determine a rider characteristic for allowance onto a particular attraction. Such features may be used to automate or enforce ride guidelines for any of a variety of possibilities, such as positioning riders in particularly assigned locations for ride operation (e.g., to ensure balanced ride vehicles, persons of certain heights within certain positions, such as children within interior seats of a ride vehicle, etc.).

Alternatively, or in addition to the prevention (e.g., automatic) of ride entrance when in the “NO GO” mode, other elements (e.g., non-automatic or notification-based) of the “Smart Start” system may be engaged (e.g., a light or lights may be illuminated so as to indicate to an employee whether the attraction is in the “NO GO” and/or the “GO” mode). An operator console 102 having an emergency stop (“E-Stop”) button or control 103 and a launch button or control 104 may be provided in such embodiments in order to allow for manual control (e.g., by an employee or operator) over the entrance of a rider from the loading zone 125 to the further portion 130 of the attraction. Such manual control may be provided in conjunction with, or in replacement of, automatic entrance control in various embodiments.

As mentioned above and as discussed in greater detail below, a variety of inputs to the “Smart Start” system may be used for determining whether the attraction should be placed in the “NO GO” or “GO” mode. FIG. 1 also illustrates a line or conduit 109 (e.g., an air line) connected with a gauge or meter 108 having markings or other feedback to illustrate a desired or preferred zone 107 of pressure (e.g., air pressure) and an undesired or non-preferred zone 110 of pressure. Although only one line 109 and/or gauge 108 is illustrated in FIG. 1, alternative embodiments may use any number of lines and/or gauges as needed for a given attraction. Such lines may be connected with equipment used by the attraction to operate various of its equipment that cause movement or other operation of the ride. In alternative embodiments, such lines may be electrical or signal-based (e.g., a wired conductor and/or wireless connection). Accordingly, if a particular pressure (or other signal) is indicated, via the gauge 108, to be operating or close to operating in an undesired manner, it may indicate a potential problem, malfunction, and/or need or desire for maintenance (e.g., routine maintenance) with the equipment the line 109 is connected with.

The line 109 may be configured as an input into the “Smart Start” system to put (e.g., automatically) the attraction into a particular mode (e.g., a “NO GO” or “GO” mode). As discussed above, the gauge 108 may aid an operator to manually control entrance of a rider onto the attraction, in addition to, or in replacement of, an automatic system. Any of a variety of equipment, beyond merely air pressure lines and/or scales, such as flow sensors, water depth in a pool or flume, nozzle pressure, detection of presence of a rider, etc. may be used for intelligently controlling ride operation, as discussed in greater detail below.

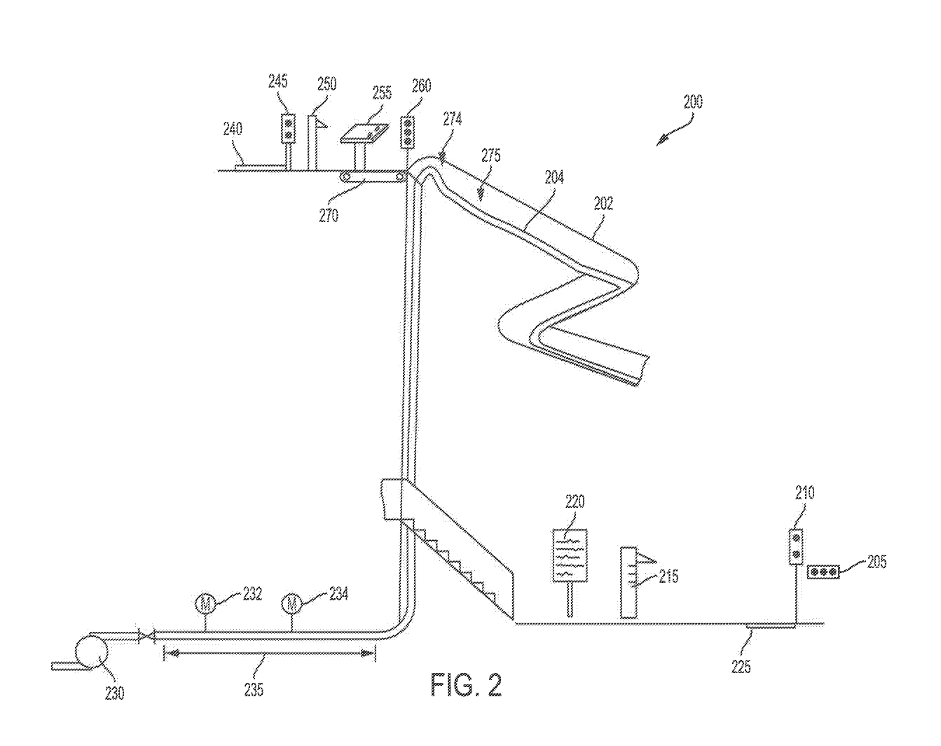

FIG. 2 shows a schematic view of a portion of a water attraction 200 and incorporating associated equipment and controls for operation. Certain features of FIG. 2 may be the same as or similar to those discussed above. For example, the attraction 200 may operate using a “Smart Start” feature that incorporates one or more inputs to automatically and/or manually indicate the water attraction 200 is OK for a particular rider, rider(s), and/or ride vehicle(s) to enter the attraction, as discussed herein. The water attraction 200 may post guidelines, rider and/or ride vehicle characteristic thresholds, and/or rules 220 (e.g., at a top of the attraction and/or near an entrance to the attraction and/or near an entrance to a queue line for the attraction). These guidelines, thresholds, and/or rules 220 may specify particular rider and/or ride vehicle characteristics that are required to be able to participate on the ride (e.g., height, weight, age, etc.). A rider and/or ride vehicle may first enter a loading zone 270 for the water attraction 200 before being permitted to travel to a further portion 274, such as a flume or slide 202 that operates to flow the rider (e.g., upon a flow of water 204) from one part of the ride (e.g., at a higher elevation) to another part of the ride (e.g., at a lower elevation).

A permission indicator 245 may be disposed near the loading zone 270 and provide one or more lights or other indicators that show the permission status (e.g., “NO GO” or “GO”) for a particular rider and/or ride vehicle to interact with the water attraction 200. Additionally, or alternatively, other locations for the permission indicator 245 and/or a second permission indicator 210, such as at an entrance to a queue line for the water attraction 200, may be used. The permission indicator 245 and/or the second permission indicator 210 may include a variety of feedback to a potential rider (e.g., indicating that the rider should travel along a particular path, such as an exit path, and/or other ride portion if the rider does not meet one or more regulations or guidelines for the attraction). In certain embodiments, the exit path may not be noticeably marked as an exit and/or the permission indicator 245 and/or the second permission indicator 210 may not be explicitly marked or indicating that a rider is not allowed on the ride in order to help prevent rider embarrassment. The attraction 200 may continue to operate fully and/or may have portions of its operation disabled (e.g., water jets such as entry water jets or other zone water jets) in the event of a permission or non-permission of a particular rider.

For example, if the water attraction 200 requires riders and/or ride vehicle with rider(s) be above and/or below a certain weight, a scale 240 may be connected (e.g., electrically such as via a wired connection or wireless connection, mechanically, etc.) with the permission indicator 245 (and/or a second scale 225 connected with the second permission indicator 210) to indicate to the rider (or operator/ride) whether the rider and/or ride vehicle is permitted to ride. Similarly, for example, if the water attraction 200 requires riders to be above and/or below a certain height, a measurement equipment or set of components 250 (e.g., light or laser beam disposed at a desired height, etc.) may be connected with the permission indicator 245 (and/or a second measurement equipment or set of components 215 with the second permission indicator 210) to indicate to the rider whether the rider is permitted to ride. Any of a variety of possible inputs that are based upon or determined from additional equipment may be provided to the permission indicator 245 and/or the second permission indicator 210 for the permission indicator 245 and/or the second permission indicator 210 to properly evaluate from all or some of the inputs whether permission for a particular rider and/or ride vehicle is granted. In some embodiments, certain inputs may be attraction based (e.g., that one or more equipment on the ride is not in a malfunctioning state), as previously discussed.

In another embodiment, if a rider does not meet one or more requirements and/or guidelines for the attraction 200, instead of the attraction 200 prohibiting rider entry to the attraction 200 and/or indicating that the rider and/or ride vehicle may not enter the attraction 200 as a whole, only certain portions of the attraction 200 may be prohibited or indicated as not allowable for a rider. For example, if an attraction includes a play center with multiple paths or elements that a user can engage with, certain paths or elements may require different user characteristics than others. Instead of the entire play center being prohibited for rider entry, a rider with one or more characteristics may only be prevented to a portion of the attraction or play center, but still allowed or indicated as allowed for others.

One or more ride status indicators (260, 205) may be disposed near the loading zone 270 and/or near an entrance to a queue line for the water attraction 200 and may provide one or more lights or other indicators as to the status of the water attraction 200 (e.g., whether it is in the “ENTER” or “WAIT” or “STOP” mode). Any of a variety of status modes may be capable of being shown by the ride status indicators (260, 205), for example, the “WAIT” status indicator may be shown if the rider is otherwise permitted to enter the ride due to height, weight, or other characteristic that were determined by the permission indicator 245 and/or its inputs, but must wait until the “ENTER” mode is activated indicating that other inputs to the “Smart Start” system have been satisfied, such as attraction-based inputs (e.g., other equipment associated with the water attraction 200, have been determined to be operating properly, such as other riders and/or ride vehicle(s) having properly reached a desired location along the ride such that a new rider and/or ride vehicle may be permitted to enter, etc.). As discussed above, the entrance of the rider from the loading zone 270 to the further portion 274 of the ride may be automatic (e.g., via a conveyor such as a flush mount dry conveyer, water jets, a rider control bar or gate, etc.) or it may be accomplished via manual intervention by an employee or operator (e.g., the employee or operator permits entrance via an operator console 255).

As mentioned, the water attraction 200 may use a variety of equipment in order to properly operate the water attraction 200. For example, a fluid or water pump 230 may be used for providing the flow of water 204 upon the slide or flume 202. Proper operation of the pump 230 may be important to the desired operation of the water attraction 200, for example, to ensure enough lubrication is being provided to one or more portions of the water attraction 200 to support desired rider and/or ride vehicle travel thereon. Accordingly, in one embodiment, a first measuring device 232 (e.g., a flowmeter) may be disposed or connected with or along a pipe used for conveying water from the pump 230 to a desired location at or along the water attraction 200. Similarly, a second measuring device 234 (a flowmeter) is also disposed along the pipe such that the first and second flowmeters (232, 234) are positioned within a length 235 (e.g., minimum length) of the pipe run. The first and second measuring devices (232, 234) may be used to sense the pressure of water, volume of water, or other determination corresponding to the flow of fluid traveling along the pipe. For example, water flow between the first measuring device 232 and the second measuring device 234 must be within a predetermined or threshold (e.g., percentage or value) of each other and/or both the first and second measuring devices (232, 234) must be within a prescribed (e.g., predetermined) range.

The output or signals from the first and second flowmeters may be provided to a processor, controller, or other component that is connected with the ride status indicator 260 (and/or the second ride status indicator 205). In this fashion, if the first and/or second measuring devices (232, 234) indicate that operation of the pump 230 or other problem exists with the flow of water 204, the ride status indicators (260 and/or 205) may illuminate or indicate a “STOP” condition. Such a “STOP” condition may be in conjunction with other equipment configured to prevent rider entrance to the ride until all stop conditions have been cleared or resolved and an “ENTER” condition is established. Greater or fewer measuring devices and/or other equipment used for determining proper operation of the water attraction 200 and/or that a rider meets the guidelines or requirements of the ride may be used in alternative embodiments.

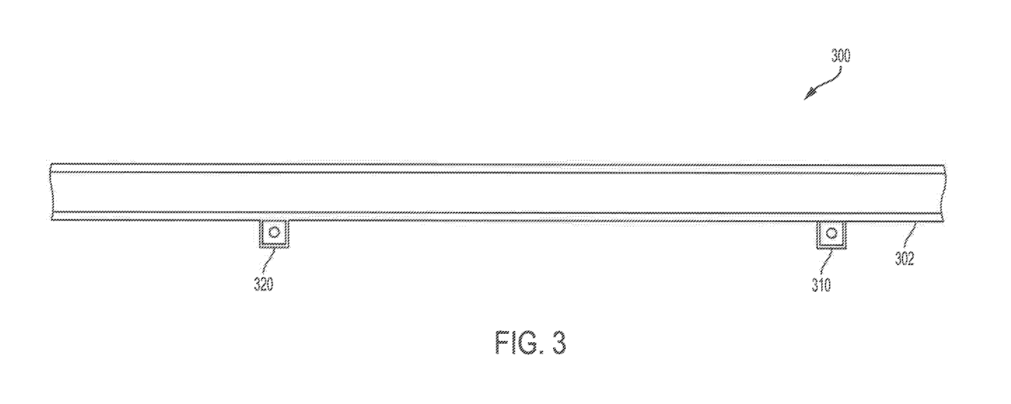

FIG. 3 shows a side view of a portion 300 of a slide (e.g., a flume) in a water attraction and incorporating associated equipment and/or controls. Certain features of the water attraction may be the same as or similar to those previously discussed. For example, the water attraction may be capable of making determinations, via or based upon signals or input from one or more of a variety of equipment or components, that control or impact desired operation of the water ride. This operation may be for management of the ride (e.g., managing of queue lines and/or rider entry/exit from the water ride, control of one or more features of the ride, or other operation, such as safety features or proper functioning of the ride). FIG. 3 illustrates one embodiment including a first water level sensor 310 and a second water level sensor 320 disposed at fixed locations along a ride surface 302. The ride surface 302 may be any of a variety of ride surfaces along the water attraction (e.g., a flume, a slide, a run-out lane, for example, intended to slow a rider and/or ride vehicle down at the conclusion of the water attraction, etc.).

The first and second water level sensors (310, 320) may be connected with a system (e.g., processor, controller, indicator, etc. as previously discussed) such that if one or more of the water level sensors (310, 320) determine, sense, and/or indicate a drop in water level below a threshold (e.g., predetermined) value, the water level sensors (310, 320) and/or the system connected with the water level sensors (310, 320) may place the ride into a “STOP” mode such that no additional riders and/or ride vehicles should be permitted to enter the ride until the issue is checked and/or resolved, at which time the ride may be controlled back into a “GO” mode. For example, the first water level sensor 310 and the second water level sensor 320 must be within a predetermined or prescribed range for a predetermined time or duration (e.g., 3 seconds) in order for “GO” mode to be established. In certain embodiments, more than one water level sensor must indicate a water level outside of prescribed operational range before a “STOP” mode is set. In alternative embodiments, other equipment may be used in addition to and/or in replacement of one or more of the water level sensors (310, 320) as input to a system for determining the mode for an attraction. For example, in one embodiment, a shutdown sensor array (e.g., sensors spaced 6-inches apart) may determine whether a particular area (e.g., a shutdown lane) is clear of riders and/or ride vehicles for a predetermined duration (e.g., 3 seconds).

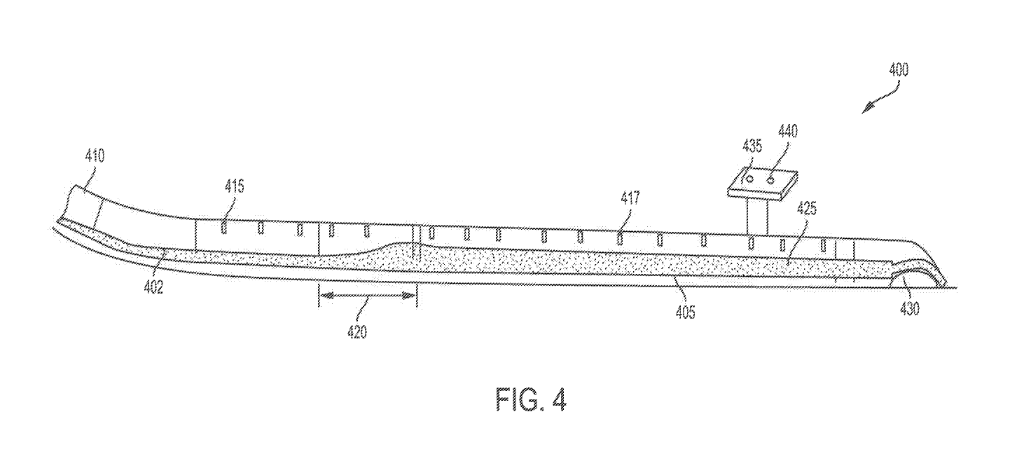

FIG. 4 shows a side view of an end portion 400 of a slide in a water attraction (such as the water attraction 200 of FIG. 2) and incorporating associated equipment and/or controls and may include features the same or similar to those previously discussed. In particular, FIG. 4 may include particular elements or components, in one embodiment, for determining operational status of the attraction in order to control one or more features of the attraction based upon such operational status. For example, with continued reference to FIG. 2, upon the rider(s) or ride vehicle encountering a first sensor 410 at the end portion 400 of a ride attraction such as the water attraction 200 a status indicator (e.g., ride status indicator 260) may change to a mode (e.g., a “WAIT” mode) indicative that the ride is still operational and accepting of new riders and/or ride vehicles, but that no new riders and/or ride vehicles should begin traversal until a later time. For example, the status indicator may illuminate with a yellow light in one embodiment.

In a manual-clearing attraction, an operator or ride attendant (e.g., positioned at an exit from the attraction), may interface with a “clear” button or element 440 on an exit location operator panel 435 once the operator or ride attendant witnesses the rider and/or ride vehicle that was sensed by the first sensor 410 having exited from the end portion 400 of the attraction (e.g., a shutdown lane of the attraction) or is otherwise in a safe location such that new rider's should be permitted to begin traversal of the attraction. This may cause the status indicator (e.g., ride status indicator 260) to return to “ENTER” mode and the process may repeat. Additional and/or alternative equipment, in addition to or in replacement of a ride operator or attendant at an exit for the water attraction 200 may be used for the above “clearing” of the “WAIT” mode, for example, automatically or without manual-clearing. For example, a sensor array 415 within the end portion 400 may include periodically spaced sensors extending along a distance of the end portion 400 that are configured to sense when an object is within a vicinity of one of more of the sensors. The “WAIT” mode may be automatically cleared based upon the sensor array 415 detecting or determining when a rider and/or ride vehicle has exited from the end portion 400 and/or the end portion 400 has remained clear for a particular duration (e.g., 3 seconds).

As also shown in the embodiment of FIG. 4, the end portion 400 (e.g., shutdown lane of a water attraction) may have a flow transition zone 420 where the flowing water on the attraction changes in characteristic from a thinner volume or flow of water (e.g., for flow along the attraction ride surface or flume prior to reaching the end portion 400) to a thicker or fuller volume or flow of water within a slowdown portion 405 of the end portion 400 to aid in slowing a rider and/or ride vehicle for that rider's and/or ride vehicle's exit from the attraction. Various flow sensors or markers (e.g., one or more flow transition sensors or markers 417 and/or operational water level markers 425) may visually or otherwise indicate to a ride operator and/or to a system of the attraction whether the volume of water in or after the flow transition zone 420 is sufficient per ride guidelines to desirably slow a rider and/or ride vehicle. Similarly, other equipment, such as an overflow weir 430 that permits water above a particular level to exit and drain may desirable help maintain water at a desired level within the end portion 400. The overflow weir 430 may be adjustable or controllable, based upon one or more of the flow transition sensors or markers 417 and/or operational water level sensors or markers 425, in order to set or adjust the particular water level at which the weir 430 permits exit or drain of water.

In addition or in replacement to the above disclosed features of an amusement attraction, other features may be included that utilize the same, similar or different equipment. For example, rather than systems designed to aid in rider control or management regarding entrance to an amusement attraction, systems and equipment may be incorporated into an amusement attraction, such as a water slide, that efficiently controls operation of the ride while a rider and/or ride vehicle is traveling upon or interacting with the ride. Conventional water rides normally provide a flow of water onto the entire ride surface of the water slide while it is in operation. Such conventional operation typically requires one or more pumps operating continuously to provide a flow of water to the rideable surfaces of the water slide, even if there is not a rider and/or ride vehicle presently near such riding surfaces. In one embodiment of an attraction using the inventive features described throughout, “Smart Flow” functionality may be incorporated such that water flow to a portion of a water slide that is not presently in use by a rider and/or ride vehicle may be disabled or turned off until a rider and/or ride vehicle comes within a predetermined distance, zone, or proximity of that portion of the water slide.

Such a “Smart Flow” system may use one or more sensors to detect the presence of a rider or ride vehicle (e.g., either via lasers, weight sensing, light sensing, movement sensing, etc.) and correspondingly enable and/or disable water jets, nozzles, or other water-delivering components based upon where the rider and/or ride vehicle is determined to be located and/or expected to be located. For example, a water slide may be broken up into 5 sequential “zones.” All of the zones may be turned off (e.g., no or minimal water flowing upon their respective ride surfaces) if no rider or ride vehicle is presently on or entering the water slide. Once a rider or ride vehicle enters or is expected to imminently enter the water slide, only the water in the first zone nearest the rider and/or ride vehicle would be enabled or turned on in greater quantity in order to facilitate the sliding movement of the rider and/or ride vehicle upon the ride surface of the first zone.

Once the rider and/or ride vehicle reaches a particular point or location along the water slide (e.g., detected via a sensor disposed at or along a location of the water slide, such as a sensor positioned within the first zone), water in the next sequential or subsequent zone (e.g., the second zone) would be enabled. Moreover, in one embodiment, as the rider and/or ride vehicle entered the second zone, water in the first zone would be reduced or turned off because the rider and/or ride vehicle was no longer riding within the first zone. Similar operation would occur for the remaining zones of the water slide. In this fashion, operation of the water may be tied to particular zone that a rider and/or ride vehicle is detected as entering or being located within (e.g., water in the second zone may be enabled once the rider and/or ride vehicle is detected within the preceding first zone and then subsequently disabled in the second zone once the rider and/or ride vehicle is detected within a later third zone). Such control of water (or other attraction features such as electricity or power, etc.) in correspondence with rider position may aid in ride efficiency, lower maintenance, lower cost, etc.

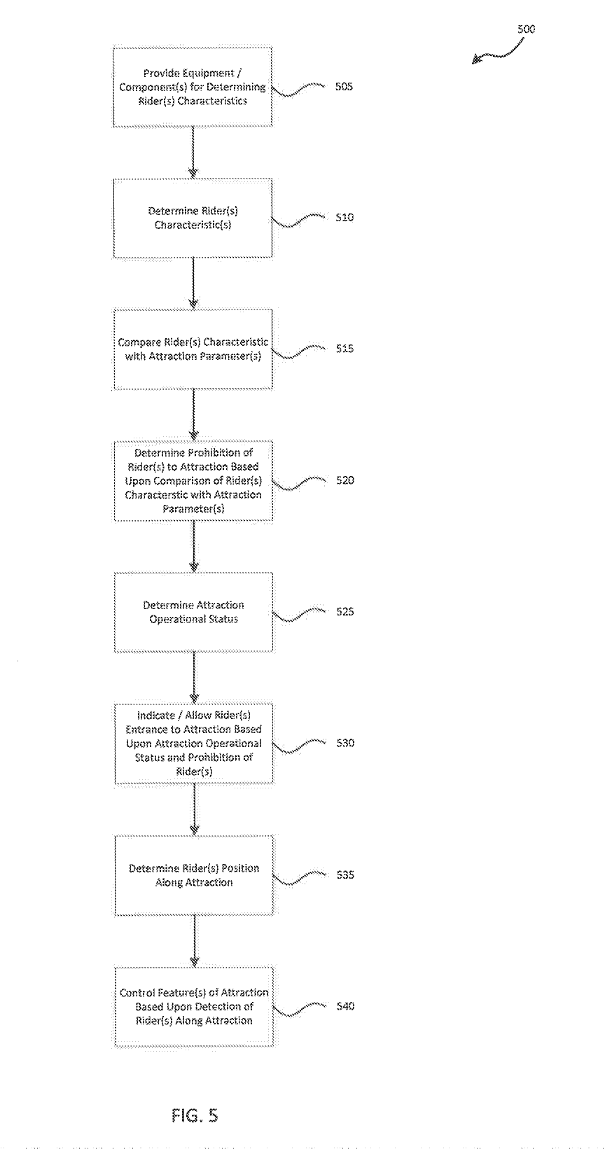

FIG. 5 shows a flowchart 500 for a method of operation of an attraction based upon rider characteristics and/or attraction status. The attraction may include features that are the same as or similar to those previously discussed. At step 505, equipment or component(s) are provided for the attraction to sense or determine one or more rider and/or ride vehicle characteristics. As previously discussed, such equipment or component(s) may include a weight measuring device, a height measuring device, and/or other equipment, such as card or tag (e.g., RFID tag, QR code, etc.) readers that scan or read a card or tag associated with a rider and/or ride vehicle (e.g., the rider may setup a profile linked to the particular card or tag that contains characteristic information about the rider and/or ride vehicle, such as weight, height, age, sex, health, or other characteristic). In one embodiment, the characteristic may not relate to biological or physical information associated with the rider, but rather to a purchase option associated with the rider (e.g., a particular status giving the rider access to additional features not available to other riders who had not purchased or otherwise obtained such status). At step 510, such equipment or component(s) of step 505 are used for determining the desired characteristic(s) of one or more riders.

At step 515, a comparison is made between the determined characteristic(s) of the one or more riders and/or ride vehicles of step 510 and attraction parameter(s) (e.g., previously stored thresholds or other parameters, such as a min/max weight, min/max height, min/max age, whether the rider(s) have a particular status associated therewith, such as VIP status, etc.). Based upon the comparison of step 515, at step 520 it is determined whether the rider(s) and/or ride vehicle(s) are prohibited or allowed to participate upon the attraction. For example, a rider that is less than 4 feet tall may not be allowed to participate if an attraction parameter requires that rider's be at least 4 feet tall in order to ride the attraction. In determining whether a rider and/or ride vehicle is prohibited or allowed, multiple characteristics for a rider and/or ride vehicle and/or multiple attraction parameters may be compared, such that some or all of the compared characteristics to parameter(s) must be satisfied per the attraction guidelines before the rider(s) and/or ride vehicle(s) are permitted to ride.

At step 525, the operational status of the attraction is determined. This may be by manual determination (e.g., a ride operator or employee may visually inspect the attraction or riders, such as ensuring riders are in a proper positioning to ride, and/or equipment associated with the attraction to determine whether the attraction is desirably operating to support further riding by riders. The operational status of the attraction may additionally or alternatively be automatically determined (e.g., equipment associated with the attraction for measuring attraction operation such as water flow, air pressure, electrical signals, etc. may be monitored without human involvement).

At step 530, whether due to manual determination or otherwise in step 525, riders are allowed (e.g., a rider may automatically be transferred from one area, such as the loading zone 270 of FIG. 2, to another and/or the attraction operator initiates the transfer via pressing of a button or control, such as on the operator panel 255 of FIG. 2) to enter the attraction based upon the determinations made in both of steps 520 and 525. For example, a ride indicator (e.g., ride indicator 260 of FIG. 2) may indicate a green light for an “ENTER” mode or condition. In alternative embodiments, such allowance or indication of allowance need not be based upon both determinations (e.g., riders and/or ride vehicles may be allowed on merely due to determination of attraction operational status of step 525 without being based upon determination of prohibition of rider(s) due to comparison of rider characteristics with attraction parameters of step 520).

At step 535, as the rider(s) and/or ride vehicle(s) travel along the attraction, the rider's and/or ride vehicle's position is determined, for example, using sensors or other equipment disposed at fixed locations along the attraction that are tripped or otherwise sense when the rider(s) and/or ride vehicle(s) are in a vicinity. In an alternative embodiment, sensors may not be used for determining position of rider(s) and/or ride vehicle(s) (e.g., rider and/or ride vehicle position may be determined based upon elapsed time from when the rider(s) and/or ride vehicle(s) entered the attraction, etc.). At step 540, other features of the attraction are controlled based upon such determinations of rider and/or ride vehicle positioning in step 535. For example, water flow, power, or other features corresponding to one or more portions of the attraction may be turned on or off depending upon the presence or expected presence of the rider(s) and/or ride vehicle(s) within those one or more portions. In another example, an indicator (e.g., status indicator 260 of FIG. 2) may be updated in response to the determinations of rider and/or ride vehicle positioning, such as illuminating a red light indicating that the attraction is in a “STOP” condition or mode where further riders should not yet enter the attraction until the rider(s) and/or ride vehicle(s) currently traversing the attraction are at or passed a particular portion of the attraction. In alternative embodiments, any of a variety of features for the attraction may be controlled, or not controlled, in order to respond to determination of rider and/or ride vehicle positioning.

As discussed above, ride or other amusement attraction operation may be desirably controlled based upon rider and/or ride vehicle characteristics and/or rider and/or ride vehicle location along the attraction. Any of a variety of combinations may be used for a desired attraction (e.g., an attraction may use one or more “Smart Start” features (e.g., to control rider entry to the attraction) without any “Smart Flow” features (e.g., enabling or disabling of particular attraction features based upon rider positioning while traversing the attraction). Correspondingly, an attraction may use one or more “Smart Flow” features to control certain components of a ride based upon rider and/or ride vehicle location and/or positioning without any “Smart Start” features, or an attraction may use one or more “Smart Start” features in combination with one or more “Smart Flow” features). The number and/or complexity of the features described herein may impact the amount of equipment and/or components necessary for effectuating such features and thereby may impact the package and/or price of such an attraction.

Various features involving sensing and/or determining a rider characteristic (e.g., weight, height, etc.), for example, in order to effectuate certain features previously described, may also be used for controlling operation of one or more components of an attraction. For example, if a scale, such as scale 120 of FIG. 1 determines that a rider and/or ride vehicle has a weight (e.g., a combined weight) within an acceptable threshold for the attraction 100, the attraction 100 may also use the determined weight for control of water jets (e.g., a heavier rider may need additional water jets and/or additional water throughput or volume or pressure in order to successfully move the rider desirably along the attraction). Any of a variety of attraction operation may be controlled based upon one or more characteristics that are determined for a rider and/or ride vehicle (e.g., additional power supplied to pumps, nozzles, motors, and/or any of a variety of possible mechanical and/or electrical devices in control of some portion of an attraction's operation. In another embodiment, the determination of one or more rider and/or ride vehicle characteristics may also be used to aid in repair and/or maintenance schedules (e.g., if a number of heavy riders travel along an attraction such that additional water pressure, volume, etc. are required for successful operation, the ride may need and/or indicate that maintenance work should be performed earlier or more prevalently than if a number or series of lighter riders traveled along the ride)

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. An amusement attraction for riding by one of a rider or a ride vehicle comprising:
a ride surface having a loading portion and a ride portion;
a detecting component configured to determine a characteristic corresponding to the rider or the ride vehicle; and
a status indicator configured to indicate whether the attraction permits entrance by the rider or the ride vehicle based upon the detecting component,
wherein the rider or the ride vehicle is automatically prevented from transitioning from the loading portion of the ride surface to the ride portion of the ride surface if the status indicator indicates entrance by the rider or the ride vehicle is not permitted.

2. The attraction of claim 1 wherein the detecting component is configured to detect a weight of the rider or the ride vehicle.

3. The attraction of claim 1 further comprising a height detecting component and wherein the status indicator is configured to indicate whether entrance by the rider or the ride vehicle is permitted based upon the height detecting component.

4. The attraction of claim 1 further comprising a fluid flow detecting component and wherein the status indicator is configured to indicate whether entrance by the rider or the ride vehicle is permitted based upon the fluid flow detecting component.

5. The amusement attraction of claim 1 further comprising a fluid level detecting component and wherein the status indicator is configured to indicate whether entrance by the rider or the ride vehicle is permitted based upon the fluid level detecting component.

6. The amusement attraction of claim 1 further comprising a pressure detecting component and wherein the status indicator is configured to indicate whether entrance by the rider or the ride vehicle is permitted based upon the pressure detecting component.

7. The amusement attraction of claim 6 wherein the pressure detecting component is configured to detect a water pressure.

8. The amusement attraction of claim 6 wherein the pressure detecting component is configured to detect an air pressure.

9. The amusement attraction of claim 1 wherein the status indicator comprises a light.

10. The amusement attraction of claim 1 wherein the status indicator comprises a sound.

11. A water attraction comprising:
a sliding surface configured to support a rider or a ride vehicle thereon, the sliding surface having a first zone; and
a sensor configured to sense the rider or the ride vehicle when the rider is in a first position along the sliding surface,
wherein a flow of water is configured to flow upon the first zone of the sliding surface based on the sensor sensing the rider or the ride vehicle when the rider or the ride vehicle is in the first position along the sliding surface.

12. The water attraction of claim 12 further comprising:
a second sensor configured to sense the rider or the ride vehicle when the rider or the ride vehicle is in a second position along the sliding surface,
wherein the flow of water that is configured to flow upon the first zone of the sliding surface is reduced based on the second sensor sensing when the rider or the ride vehicle is in the second position along the sliding surface.

13. A method for controlling an amusement attraction for riding by a rider or a ride vehicle comprising:
determining a characteristic of the rider or the ride vehicle;
comparing the characteristic of the rider or the ride vehicle with a parameter of the amusement attraction;
determining prohibition of the rider or the ride vehicle based upon the comparing of the characteristic of the rider or the ride vehicle with the parameter of the amusement attraction; and
indicating allowance of the rider or the ride vehicle based upon the determining of the prohibition of the rider.

14. The method of claim 13 wherein the determining the characteristic of a rider or the ride vehicle includes reading a tag associated with the rider r the ride vehicle.

15. The method of claim 14 wherein the tag is an RFID tag.

16. The method of claim 13 further comprising:
determining a status of the amusement attraction, and
wherein the indicating allowance of the rider or the ride vehicle is based upon the status of the amusement attraction.

17. The method of claim 16 wherein the status of the amusement attraction corresponds to a malfunction of the amusement attraction.

18. The method of claim 13 further comprising determining a position of the rider or the ride vehicle along the amusement attraction.

19. The method of claim 18 further comprising controlling a flow of water that flows along at least a portion of the amusement attraction based upon the determining of the position of the rider or the ride vehicle along the amusement attraction.

20. The method of claim 18 further comprising controlling an electrical signal based upon the determining of the position of the rider or the ride vehicle along the amusement attraction.
